(19) United States
(12) Patent Application Publication
(10) Pub. No.: US 2013/0165194 A1
(43) Pub. Date: Jun. 27, 2013

(54) GAME DEVICE, METHOD OF CONTROLLING A GAME DEVICE, AND INFORMATION STORAGE MEDIUM

(71) Applicant: Konami Digital Entertainment Co., Ltd., Tokyo (JP)

(72) Inventor: Shinta NOJIRI, Sumida-ku (JP)

(73) Assignee: KONAMI DIGITAL ENTERTAINMENT CO., LTD., Tokyo (JP)

(21) Appl. No.: 13/718,409

(22) Filed: Dec. 18, 2012

(30) Foreign Application Priority Data
Dec. 22, 2011 (JP) 2011-281418

(51) Int. Cl. A63F 13/04

(52) U.S. Cl. CPC A63F 13/04
USPC 463/5

(57) ABSTRACT

A display control unit of a game device causes a display unit to display a virtual space image showing how a virtual space is viewed from a virtual viewpoint, and causes the display unit to display a first sighting image indicating a sighting of a first ejector and a second sighting image indicating a sighting of a second ejector on the virtual space image in a superimposed manner. A sighting control unit controls a display position of the first sighting image and a display position of the second sighting image so that an overlapping region of part of the first sighting image and part of the second sighting image includes a center point of the virtual space image.

### CROSS-REFERENCE TO RELATED APPLICATION

The present application claims priority from Japanese application JP 2011-281418 filed on Dec. 22, 2011, the content of which is hereby incorporated by reference into this application.

### BACKGROUND OF THE INVENTION

1. Field of the Invention

The present invention relates to a game device, a method of controlling a game device, and an information storage medium.

2. Description of the Related Art

Up to now, there has been known a game device for executing a game configured so that an operation subject of a player shoots a moving object (for example, bullet) from a first ejector and a second ejector. Japanese Patent Application Laid-open No. 2011-101764 describes a technology for separately displaying a first sighting mark indicating the sighting of a first ejector and a second sighting mark indicating the sighting of a second ejector, and in response to the operation of the player, for example, moving those two sighting marks independently and displaying only one sighting mark.

### SUMMARY OF THE INVENTION

However, with the technology described in Japanese Patent Application Laid-open No. 2011-101764, in a case where two sighting marks are moved independently, the two sighting marks move separately, and hence it has been difficult for the player to aim at the target. On the other hand, in a case where only one sighting mark corresponding to two weapons is displayed, it is easy for the player to aim at the target, but it is hard for the player to enjoy the feeling of using two weapons at the same time.

The present invention has been made in view of the above-mentioned problem, and has an object to provide a game device, a method of controlling a game device, and an information storage medium, which enable a player to easily aim at targets of a plurality of weapons and to easily have an actual feeling of operating the plurality of weapons.

In order to solve the above-mentioned problem, according to an exemplary embodiment of the present invention, there is provided a game device for executing a game configured so that a moving object is shot from each of a first ejector and a second ejector based on an operation of a player, the game device including: display control means for causing display means to display a virtual space image showing how a virtual space is viewed from a virtual viewpoint, and causing the display means to display a first sighting image indicating a sighting of the first ejector and a second sighting image indicating a sighting of the second ejector on the virtual space image in a superimposed manner; moving object control means for, based on the operation of the player, shooting the moving object from the first ejector toward a position within the virtual space corresponding to a display position of the first sighting image, and shooting the moving object from the second ejector toward a position within the virtual space corresponding to a display position of the second sighting image; and sighting control means for controlling the display position of the first sighting image and the display position of the second sighting image so that an overlapping region of part of the first sighting image and part of the second sighting image includes a center point of the virtual space image.

According to the exemplary embodiment of the present invention, there is also provided a method of controlling a game device for executing a game configured so that a moving object is shot from each of a first ejector and a second ejector based on an operation of a player, the method including: a display control step of causing display means to display a virtual space image showing how a virtual space is viewed from a virtual viewpoint, and causing the display means to display a first sighting image indicating a sighting of the first ejector and a second sighting image indicating a sighting of the second ejector on the virtual space image in a superimposed manner; a moving object control step of, based on the operation of the player, shooting the moving object from the first ejector toward a position within the virtual space corresponding to a display position of the first sighting image, and shooting the moving object from the second ejector toward a position within the virtual space corresponding to a display position of the second sighting image; and a sighting control step of controlling the display position of the first sighting image and the display position of the second sighting image so that an overlapping region of part of the first sighting image and part of the second sighting image includes a center point of the virtual space image.

According to the exemplary embodiment of present invention, there is further provided a program for causing a computer to function as a game device for executing a game configured so that a moving object is shot from each of a first ejector and a second ejector based on an operation of a player, the game device including: display control means for causing display means to display a virtual space image showing how a virtual space is viewed from a virtual viewpoint, and causing the display means to display a first sighting image indicating a sighting of the first ejector and a second sighting image indicating a sighting of the second ejector on the virtual space image in a superimposed manner; moving object control means for, based on the operation of the player, shooting the moving object from the first ejector toward a position within the virtual space corresponding to a display position of the first sighting image, and shooting the moving object from the second ejector toward a position within the virtual space corresponding to a display position of the second sighting image; and sighting control means for controlling the display position of the first sighting image and the display position of the second sighting image so that an overlapping region of part of the first sighting image and part of the second sighting image includes a center point of the virtual space image.

According to the exemplary embodiment of the present invention, there is also provided a non-transitory computer readable information storage medium having recorded thereon the above-mentioned program.

According to the present invention, a player is enabled to easily aim at targets of a plurality of weapons and to easily have an actual feeling of operating the plurality of weapons.

Further, according to the exemplary embodiment of the present invention, the game includes a game configured so that, based on the operation of the player, an operation subject including a plurality of determination target body parts shoots the moving object from the each of the first ejector and the second ejector to make an attack against an enemy disposed within the virtual space, and the game device further includes: damage determination means for determining, for each of the plurality of determination target body parts, whether or not damage is inflicted on the each of the plurality of determination target body parts by an attack made by the enemy; means for separating, based on a result of determination obtained by the damage determination means, one of the plurality of determination target body parts from a main body portion of the operation subject; and means for acquiring, from means for storing a body part condition regarding a combination of ones of the plurality of determination target body parts that are included in the main body portion and positional relationship information relating to a positional relationship between the first sighting image and the second sighting image in association with each other, the positional relationship information, and the sighting control means controls the display position of the first sighting image and the display position of the second sighting image based on the positional relationship information associated with the body part condition satisfied by a current combination of the ones of the plurality of determination target body parts that are included in the main body portion.

Further, according to the exemplary embodiment of the present invention, the game includes a game configured so that, based on the operation of the player, an operation subject shoots the moving object from the each of the first ejector and the second ejector to make an attack against an enemy disposed within the virtual space, the operation subject uses the first ejector by using a predetermined body part, and the game device further includes: damage determination means for determining whether or not a damage is inflicted on the predetermined body part by an attack made by the enemy; and means for separating, based on a result of determination obtained by the damage determination means, the predetermined body part from a main body portion of the operation subject, and disposing the separated predetermined body part in the virtual space, and the moving object control means shoots, in a case where the predetermined body part is separated from the main body portion, in response to the operation of the player, the moving object in a representative direction of the first ejector from a position at which the separated predetermined body part is disposed.

Further, according to the exemplary embodiment of the present invention, the sighting control means includes means for erasing the first sighting image and changing at least one of the display position, a shape, and an area of the second sighting image in the case where the predetermined body part is separated from the main body portion.

Further, according to the exemplary embodiment of the present invention, the game includes a game configured so that based on the operation of the player, an operation subject shoots the moving object from the each of the first ejector and the second ejector, and the game device further includes: means for moving, in response to the operation of the player, at least one of the operation subject and the virtual viewpoint; and means for acquiring, from means for storing a speed condition regarding a moving speed of the at least one of the operation subject and the virtual viewpoint and positional relationship information relating to a positional relationship between the first sighting image and the second sighting image in association with each other, the positional relationship information, and the sighting control means controls the display position of the first sighting image and the display position of the second sighting image based on the positional relationship information associated with the speed condition satisfied by a current moving speed of the at least one of the operation subject and the virtual viewpoint.

Further, according to the exemplary embodiment of the present invention, an association between the speed condition and the positional relationship information is set so that depending on the moving speed of the at least one of the operation subject and the virtual viewpoint, an area of the overlapping region of the first sighting image and the second sighting image is increased or decreased, and the sighting control means controls the display position of the first sighting image and the display position of the second sighting image based on the positional relationship information associated with the speed condition satisfied by the current moving speed of the at least one of the operation subject and the virtual viewpoint, to thereby control the display position of the first sighting image and the display position of the second sighting image so that depending on the moving speed of the at least one of the operation subject and the virtual viewpoint, the area of the overlapping region of the first sighting image and the second sighting image is increased or decreased.

Further, according to the exemplary embodiment of the present invention, in the game, of a plurality of kinds of ejectors, ones of the plurality of kinds of ejectors specified by the player are used as the first ejector and the second ejector, the game device further includes means for acquiring, from means for storing an ejector condition regarding a combination of a kind of the first ejector and a kind of the second ejector and positional relationship information relating to a positional relationship between the first sighting image and the second sighting image in association with each other, the positional relationship information, and the sighting control means controls the display position of the first sighting image and the display position of the second sighting image based on the positional relationship information associated with the ejector condition satisfied by a current combination of the kind of the first ejector and the kind of the second ejector.

Further, according to the exemplary embodiment of the present invention, an association between the ejector condition and the positional relationship information is set so that depending on the combination of the kind of the first ejector and the kind of the second ejector, an area of the overlapping region of the first sighting image and the second sighting image is increased or decreased, and the sighting control means controls the display position of the first sighting image and the display position of the second sighting image based on the positional relationship information associated with the ejector condition satisfied by the current combination of the kind of the first ejector and the kind of the second ejector, to thereby control the display position of the first sighting image and the display position of the second sighting image so that depending on the combination of the kind of the first ejector and the kind of the second ejector, the area of the overlapping region of the first sighting image and the second sighting image is increased or decreased.

Further, according to the exemplary embodiment of the present invention, the moving object control means includes: means for shooting the moving object from the first ejector toward a first target position within the virtual space that is selected based on a display region of the first sighting image, and shooting the moving object from the second ejector toward a second target position within the virtual space that is selected based on a display region of the second sighting image; and means for performing a setting so that as a given point becomes closer to a position within the virtual space corresponding to a center point of the display region of the first sighting image, a probability of the given point being selected as the first target position becomes higher, and performing a setting so that as another given point becomes closer to a position within the virtual space corresponding to a center point of the display region of the second sighting image, a probability of the other given point being selected as the second target position becomes higher.

### BRIEF DESCRIPTION OF THE DRAWINGS

In the accompanying drawings:

FIG. 1 illustrates a hardware configuration of a game device according to an embodiment of the present invention;

FIG. 2 is a diagram illustrating an example of a game space;

FIG. 3 illustrates an example of a game screen displayed on a display unit;

FIG. 4 is a functional block diagram illustrating functions relevant to the present invention among functions implemented by the game device;

FIG. 5 is a diagram illustrating hit point parameters of a robot;

FIG. 6 is a diagram illustrating traveling directions of bullets;

FIG. 7 is a flowchart illustrating processing executed in a case where a game is activated in the game device;

FIG. 8 is a flowchart illustrating the processing executed in a case where the game is activated in the game device;

FIG. 9 is a diagram illustrating a data storage example of association between a body part condition and positional relationship information;

FIG. 10 is a diagram illustrating a data storage example of association between a speed condition and positional relationship information; and

FIG. 11 is a diagram illustrating a data storage example of association between an ejector condition and positional relationship information.

### DETAILED DESCRIPTION OF THE INVENTION

### 1. Embodiment

Hereinafter, detailed description is given of an example of an embodiment of the present invention with reference to the drawings. A game device according to the embodiment of the present invention is implemented by, for example, a consumer game machine (stationary game machine), a portable game machine, a cellular phone (smartphone), a personal digital assistant (PDA), or a personal computer. In the following, description is given of a case where the game device according to the embodiment of the present invention is implemented by a consumer game machine.

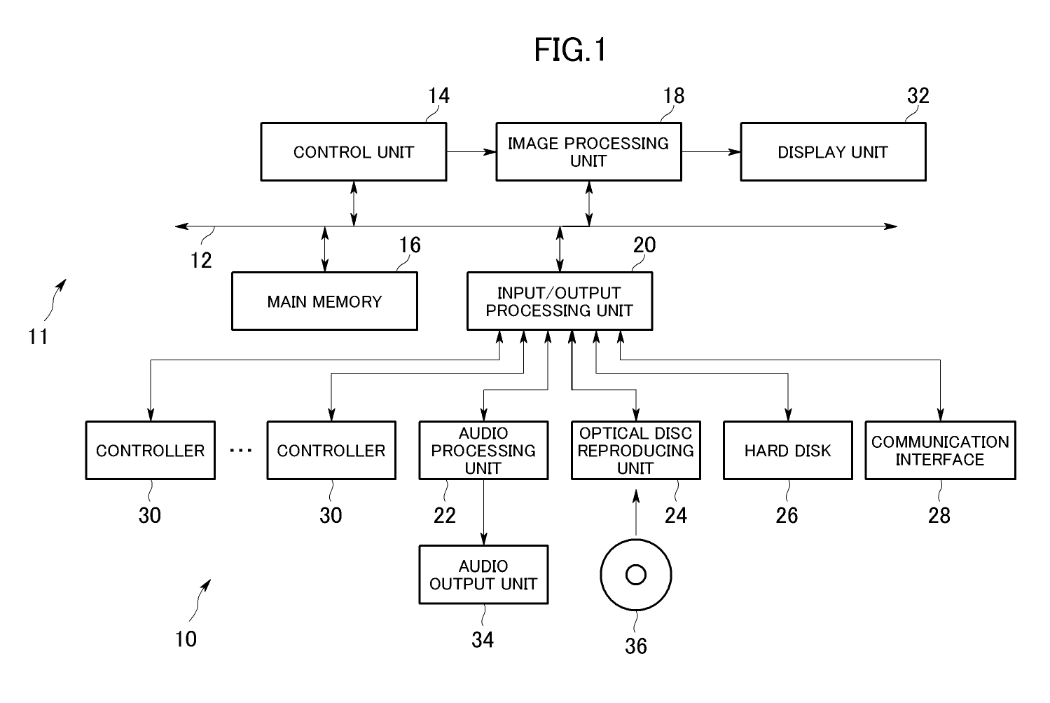

FIG. 1 illustrates a hardware configuration of the game device according to the embodiment of the present invention. The game device 10 illustrated in FIG. 1 includes a consumer game machine 11, a display unit 32, an audio output unit 34, and an optical disc 36 (information storage medium).

The display unit 32 and the audio output unit 34 are connected to the consumer game machine 11. The display unit 32 is, for example, a home-use television set or liquid crystal display. The audio output unit 34 is, for example, a speaker built into the home-use television set, or headphones.

The consumer game machine 11 is a known computer game system. The consumer game machine 11 includes a bus 12, a control unit 14, a main memory 16, an image processing unit 18, an input/output processing unit 20, an audio processing unit 22, an optical disc reproducing unit 24, a hard disk 26, a communication interface 28, and a controller 30.

The control unit 14 includes one or a plurality of control sections (for example, CPUs). The control unit 14 executes processing of controlling the respective units of the consumer game machine 11 and information processing based on an operating system stored in a ROM (not shown) and programs read from the optical disc 36.

The main memory 16 includes, for example, a RAM. The programs and data read from the optical disc 36 are written into the main memory 16. The main memory 16 is also used as a working memory for the control unit 14. The bus 12 is used for communicating addresses and data among the respective units of the consumer game machine 11.

The image processing unit 18 includes a VRAM. The image processing unit 18 renders a game screen on the VRAM based on image data supplied from the control unit 14. The game screen rendered on the VRAM is converted into video signals, and the video signals are then output to the display unit 32 at a predetermined timing.

The input/output processing unit 20 is an interface for the control unit 14 to access the audio processing unit 22, the optical disc reproducing unit 24, the hard disk 26, the communication interface 28, and the controller 30.

The audio processing unit 22 includes a sound buffer. The audio processing unit 22 outputs, from the audio output unit 34, audio data loaded from the optical disc 36 into the sound buffer.

The communication interface 28 is an interface for connecting the consumer game machine 11 by wire or wireless to a communication network, such as the Internet.

The optical disc reproducing unit 24 reads the programs and data recorded in the optical disc 36. In this embodiment, description is given of a case where the optical disc 36 is used to supply the programs and data to the consumer game machine 11, but another information storage medium, such as a memory card, may be used to supply the programs and data to the consumer game machine 11. Alternatively, for example, the programs and data may be supplied to the consumer game machine 11 from a remote site via the communication network.

The hard disk 26 is a commonly-used hard disk device (auxiliary storage device). Note that the programs and data that are described as being stored in the optical disc 36 in this embodiment may be stored in the hard disk 26 instead.

The controller 30 is an operation unit for a player to perform a game operation. One or a plurality of the controllers 30 are connected by wire or wirelessly to the consumer game machine 11. The input/output processing unit 20 scans the state of each operation member of the controller 30 every predetermined cycle (for example, every 1/60^{th} of a second). An operation signal representing the scanning result is supplied to the control unit 14 via the bus 12. The control unit 14 determines the game operation of the player based on the operation signal.

### 2. Game Executed by the Game Device

The game device 10 executes a game program read from the optical disc 36, to thereby execute a game configured so that a character operated by the player shoots a moving object from each of a first ejector and a second ejector. In this embodiment, description is given of a case where a third person shooter game, in which a robot operated by the player fights against an enemy character while moving in a game space, is executed. In a case where the third person shooter game is started, the game space is built in the main memory 16.

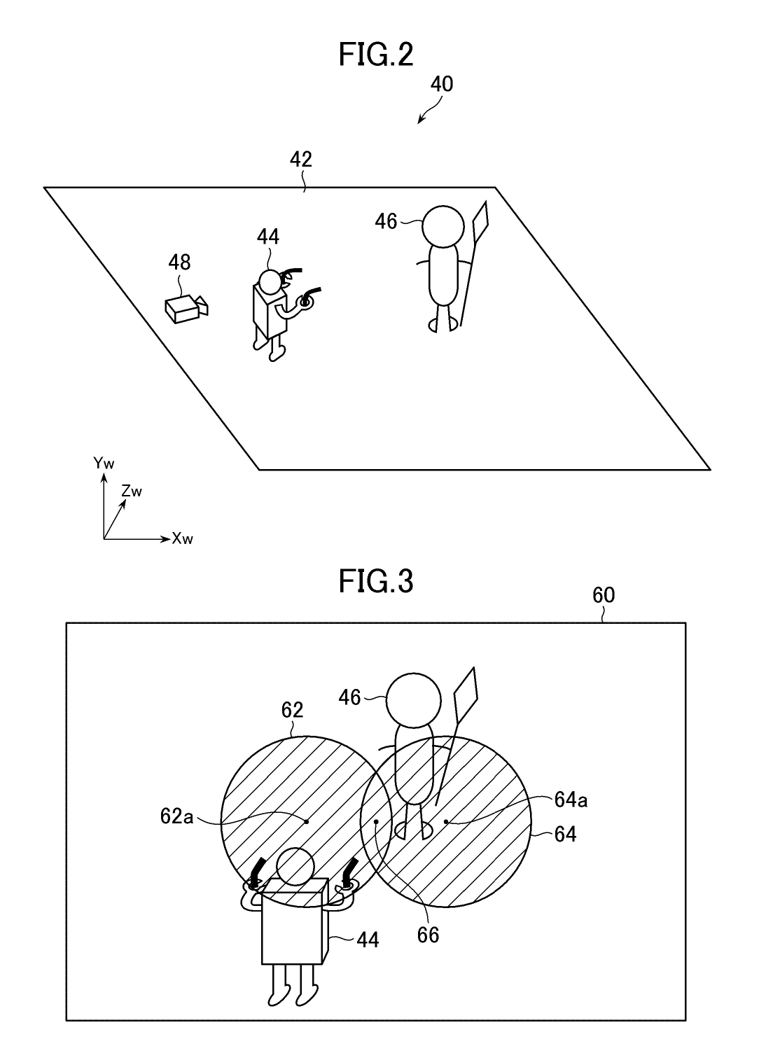

FIG. 2 is a diagram illustrating an example of a game space 40. The game space 40 illustrated in FIG. 2 is a virtual three-dimensional space in which three axes of coordinates (Xw-axis, Yw-axis, and Zw-axis) orthogonal to one another are set. As illustrated in FIG. 2, in the game space 40, there is disposed a field 42, which is an object representing a battlefield.

On the field 42, a robot 44 that is an object representing an operation subject of the player and an enemy character 46 that is an object representing an enemy game character that makes an attack against the robot 44 are disposed. The positions of the respective objects are identified by, for example, three-dimensional coordinates within a world coordinate system (Xw-Yw-Zw coordinate system).

The robot 44 acts in response to the operation of the player. In a case where the player performs a direction instruction operation, the robot 44 moves in a direction indicated by the direction instruction operation, and in a case where the player performs an attack instruction operation, the robot 44 performs an attacking action. As illustrated in FIG. 2, the robot 44 uses two guns respectively held in both hands to make an attack against the enemy character 46. In a case where the player performs the attack instruction operation, the robot 44 shoots a bullet from the gun held in the right hand, and shoots a bullet from the gun held in the left hand.

On the other hand, the enemy character 46 acts in response to the operation of a computer. The enemy character 46 autonomously acts in accordance with a predetermined algorithm, and for example, approaches the robot 44 and then performs the attacking action, or moves in such a manner that the enemy character 46 gets away from the attack made by the robot 44.

Further, in the game space 40, a virtual camera 48 (viewpoint) is set. The position and sight line direction of the virtual camera 48 are controlled based on a tracking target within the game space 40. The tracking target is an object to be included within the visual field of the virtual camera 48. In this case, the robot 44 is set as the tracking target of the virtual camera 48. For example, the position of the virtual camera 48 is a position spaced apart from the position of the robot 44 in a predetermined direction by a predetermined distance, and a representative direction (sight line direction, orientation of a face, or orientation of a body) of the robot 44 is the sight line direction of the virtual camera 48.

A game screen showing how the game space 40 is viewed from the virtual camera 48 is displayed on the display unit 32. The game screen is generated by using a predetermined coordinate conversion operation to convert coordinates of vertices of the respective objects disposed in the game space 40 from the world coordinate system into a screen coordinate system.

FIG. 3 illustrates an example of a game screen 60 displayed on the display unit 32. As illustrated in FIG. 3, in the game screen 60, objects existing within the visual field of the virtual camera 48 (in this case, the robot 44 and the enemy character 46) are included.

Further, a first sighting image 62 and a second sighting image 64, which indicate the sightings of the guns with which the robot 44 is armed, are included in the game screen 60. The first sighting image 62 is an image for guiding the player to the sighting of the gun held by the robot 44 in its left hand. The second sighting image 64 is an image for guiding the player to the sighting of the gun held by the robot 44 in its right hand. In the case where the player performs the attack instruction operation, the bullet is shot from the gun held by the robot 44 in its left hand toward a position within the game space 40 corresponding to the first sighting image 62, and the bullet is shot from the gun held by the robot 44 in its right hand toward a position within the game space 40 corresponding to the second sighting image 64.

As illustrated in FIG. 3, in this case, the first sighting image 62 and the second sighting image 64 are each a circular image, and part of the first sighting image 62 and part of the second sighting image 64 overlap with each other. Further, this overlapping region includes a center point 66 of the game screen 60. This configuration enables the player to easily aim at the target, and at the same time, enables the player to enjoy the feeling of operating two guns. The above-mentioned technology is described below in detail.

### 3. Functions Implemented by the Game Device

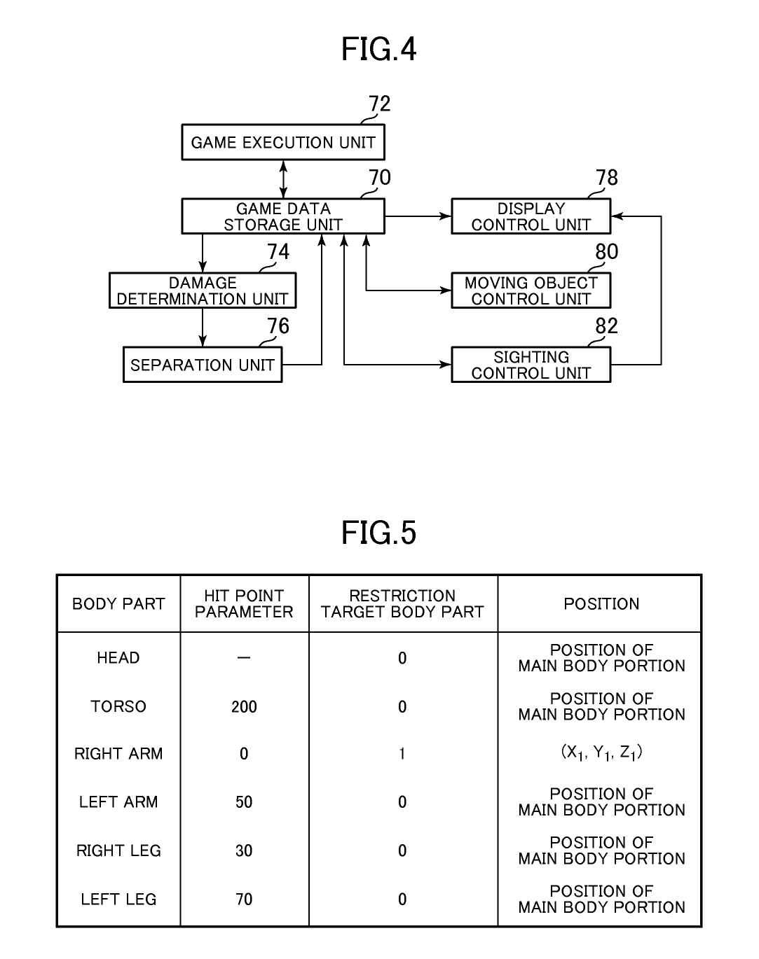

FIG. 4 is a functional block diagram illustrating functions relevant to the present invention among functions implemented by the game device 10. As illustrated in FIG. 4, the game device 10 includes a game data storage unit 70, a game execution unit 72, a damage determination unit 74, a separation unit 76, a display control unit 78, a moving object control unit 80, and a sighting control unit 82. Those functions are implemented by the control unit 14 executing the programs stored in the optical disc 36.

### (3-1. Game Data Storage Unit)

The game data storage unit 70 is implemented mainly by, for example, the main memory 16 and the optical disc 36. The game data storage unit 70 stores sighting image data relating to the first sighting image 62 and the second sighting image 64, and game situation data indicating the situation of the game that is being executed.

The sighting image data includes image data on the first sighting image 62 and the second sighting image 64 and information relating to a display position, shape, and size of each of the first sighting image 62 and the second sighting image 64. The display position of each of the first sighting image 62 and the second sighting image 64, which is controlled by the sighting control unit 82 to be described later, is stored in the sighting image data.

The game situation data includes, for example, the following pieces of data: (1) hit point parameters indicating current states (such as vital power and endurance power) of the robot 44 and the enemy character 46; (2) parameters indicating ability values (such as attacking power and defensive power) of the robot 44 and the enemy character 46; and (3) data indicating a current situation of the game space 40 (for example, current positions, postures, moving directions, and moving speeds of the robot 44 and the enemy character 46, and a current position, sight line direction, and moving speed of the virtual camera 48).

FIG. 5 is a diagram illustrating hit point parameters of the robot 44. As illustrated in FIG. 5, for each of the body parts of the robot 44 (in this case, a head 44a, a torso 44b, a right arm 44c, a left arm 44d, a right leg 44e, and a left leg 44f), a hit point parameter, which is information on a numerical value that decreases in a case where a damage is inflicted, is defined. In other words, for each of the body parts of the robot 44, it is determined whether or not the damage is inflicted by the attack made by the enemy character 46. In a case where the damages are accumulated in a given body part of the robot 44, the robot 44 loses the given body part.

In a case where the damage is inflicted on the body part of the robot 44, the value of the hit point parameter corresponding to the body part on which the damage is inflicted decreases. Further, any one of the body parts of the robot 44 (for example, the head 44a) is set as a main body part, and the hit point parameter is not set for the main body part. The main body part refers to a body part that can be operated by the player in a case where all the body parts of the robot 44 are separated. In other words, in a case where the robot 44 is continuously subjected to the attacks made by the enemy character 46 and then loses all its body parts, the only body part that can be finally operated by the player is the main body part (for example, the head 44a). Of the body parts of the robot 44, a group of one or a plurality of the body parts including the main body part is hereinafter referred to as main body portion. That is, part of the body parts of the robot 44 to be the operation subject of the player is the main body portion.

Moreover, of the body parts of the robot 44, the body part to which the hit point parameter is set is hereinafter referred to as determination target body part. The operation subject of the player (for example, the robot 44) thus includes the main body portion (for example, the head 44a that is the main body part) and a plurality of determination target body parts (for example, the torso 44b to the left leg 44f).

The extent of a decrease in the hit point parameter is determined based on at least one of the ability value (for example, the attacking power) of the enemy character 46 and the ability value (for example, the defensive power) of the robot 44. The body part on which the damage is inflicted by the attack made by the enemy character 46 is identified by a predetermined hit determination, and the value of the hit point parameter corresponding to the body part decreases by the numerical value determined based on the ability value of the enemy character 46 and the ability value of the robot 44.

In addition, of the determination target body parts, a determination target body part whose hit point parameter falls within a predetermined range and which is separated from the main body portion is set as a restriction target body part. Information indicating whether or not the determination target body part is set as the restriction target body part is stored for each determination target body part. In this case, as illustrated in FIG. 5, the fact that the value of a restriction target body part flag is “0” indicates that a corresponding body part is not set as the restriction target body part, and the fact that the value of the restriction target body part flag is “1” indicates that a corresponding body part is set as the restriction target body part. Further, the body part that is set as the restriction target body part is separated from the main body portion so as to be disposed within the game space 40, and hence information indicating the disposed position is stored.

Note that the control unit 14 functions as means for acquiring the data stored in the game data storage unit 70. Further, the data stored in the game data storage unit 70 is not limited to the above-mentioned example, and it suffices that various kinds of data required for executing the game are stored.

### (3-2. Game Execution Unit)

The game execution unit 72 is implemented mainly by the control unit 14. The game execution unit 72 executes the game configured so that the operation subject of the player shoots the moving object from each of the first ejector and the second ejector. The game execution unit 72 causes the robot 44 to act in response to the operation of the player, and causes the enemy character 46 to act in response to the operation of the computer. The game execution unit 72 updates the game situation data based on specifics of the action. Note that the processing executed by the game execution unit 72 is not limited to that described above, and the game execution unit 72 functions as an operation subject for executing various kinds of processing relating to the above-mentioned game.

### (3-3. Damage Determination Unit)

The damage determination unit 74 is implemented mainly by the control unit 14. The damage determination unit 74 determines, for each of the plurality of determination target body parts, whether or not the damage is inflicted on the determination target body part by the attack made by the enemy.

In other words, the determination target body part is, of the body parts of the robot 44, the body part to be subjected to the determination as to whether or not the damage is inflicted thereon. In this embodiment, of the body parts of the robot 44, the body parts to be the determination target body part are all the body parts except for the head 44a (the torso 44b, the right arm 44c, the left arm 44d, the right leg 44e, and the left leg 44f).

The damage determination unit 74 determines whether or not the attack made by the enemy character 46 has hit the determination target body part, to thereby determine whether or not the damage is inflicted on the determination target body part. For example, based on hit determination processing of determining whether or not the enemy character 46 or attacking means of the enemy character 46 has come into contact with the determination target body part of the robot 44, it is determined whether or not the damage is inflicted on the determination target body part.

Note that the method of determining, by the damage determination unit 74, whether or not the damage is inflicted on the determination target body part only needs to be a method determined in advance, and is not limited to the above-mentioned method. Alternatively, for example, the damage determination unit 74 may determine, based on hit determination processing of determining whether or not a predetermined object (for example, a ceiling that falls toward the robot 44, iron wire in which a high current flows, or a bomb) disposed within the game space 40 has come into contact with the determination target body part of the robot 44, whether or not the damage is inflicted on the determination target body part. Still alternatively, the damage determination unit 74 may determine, based on a given numerical expression, whether or not the attack made by the enemy character 46 has hit each of the determination target body parts.

In a case where it is determined that the damage is inflicted on the determination target body part of the robot 44, the hit point parameter corresponding to the determination target body part on which the damage is inflicted changes (decreases or increases) by a value determined based on a predetermined method. Note that the extent of the change in the hit point parameter only needs to be determined based on a method determined in advance, and is not limited to the above-mentioned case. Alternatively, for example, in a case where the damage is inflicted on the determination target body part, the hit point parameter may be modified by a value determined in advance.

### (3-4. Separation Unit)

The separation unit 76 is implemented mainly by the control unit 14. The separation unit 76 separates, based on the result of determination obtained by the damage determination unit 74, the determination target body part (for example, the torso 44b, the right arm 44c, the left arm 44d, the right leg 44e, or the left leg 44f) from the main body portion (for example, portion including the head 44a) of the operation subject (for example, the robot 44).

In a case where the hit point parameter of the determination target body part on which the damage determination unit 74 determines that the damage is inflicted falls within a predetermined range (for example, becomes a reference value or smaller), the separation unit 76 separates the determination target body part from the main body portion. In a case where a given determination target body part is separated from the main body portion, the role to be played by the given determination target body part (function of the determination target body part) is lost, and thus the action of the robot 44 is restricted (limited). For example, in a case where the robot 44 loses the right arm 44c, the robot 44 becomes unable to make an attack with the gun with which the robot 44 is armed in the right arm 44c, and in a case where the robot 44 loses the left arm 44d, the robot 44 becomes unable to make an attack with the gun with which the robot 44 is armed in the left arm 44d.

Further, the determination target body part separated from the main body portion is disposed on the field 42. In a case where the robot 44 performs a predetermined action, the separated determination target body part is joined to the main body portion. For example, in a case where the robot 44 and the determination target body part disposed on the field 42 come close to each other within a predetermined distance, the determination target body part is joined to the main body portion, and as a result, the function of the determination target body part is recovered. In a case where the determination target body part is joined to the main body portion, the value of the restriction target body part flag is changed.

Note that how the robot 44 moves may be changed depending on a combination of the body parts constituting the main body portion. For example, in a case where the right leg 44e is separated from the robot 44, the robot 44 moves in such a manner that the robot 44 hops only with the left leg 44f, and in a case where the right leg 44e and the left leg 44f are separated from the robot 44, the robot 44 moves in such a manner that the robot 44 crawls forward.

### (3-5. Display Control Unit)

The display control unit 78 is implemented mainly by the control unit 14. The display control unit 78 causes display means (for example, the display unit 32) to display a virtual space image (for example, the image of the game space 40 displayed on the game screen 60) showing how a virtual space (for example, the game space 40) is viewed from the virtual viewpoint (for example, the virtual camera 48), and causes the display means to display the first sighting image 62 indicating the sighting of the first ejector (for example, the gun held in the left arm 44d) and the second sighting image 64 indicating the sighting of the second ejector (for example, the gun held in the right arm 44c) on the virtual space image in a superimposed manner.

The display control unit 78 performs coordinate conversion processing on the objects included within the visual field of the virtual camera 48, to thereby generate the virtual space image showing a current state of the game space 40. The display control unit 78 causes the display means to display the first sighting image 62 and the second sighting image 64 respectively at display positions determined by the sighting control unit 82 to be described below so that the first sighting image 62 and the second sighting image 64 are superimposed on the virtual space image.

### (3-6. Moving Object Control Unit)

The moving object control unit 80 is implemented mainly by the control unit 14. The moving object control unit 80, in response to the operation of the player, shoots the moving object from the first ejector (for example, the gun held in the left arm 44d) toward the position within the virtual space (for example, the game space 40) corresponding to the display position of the first sighting image, and shoots the moving object from the second ejector (for example, the gun held in the right arm 44c) toward the position within the virtual space corresponding to the display position of the second sighting image.

The position within the game space 40 corresponding to the display position of the sighting image is the position within the game space 40 determined based on the display position of the sighting image, and is the position within the game space 40 associated with the display position of the sighting image.

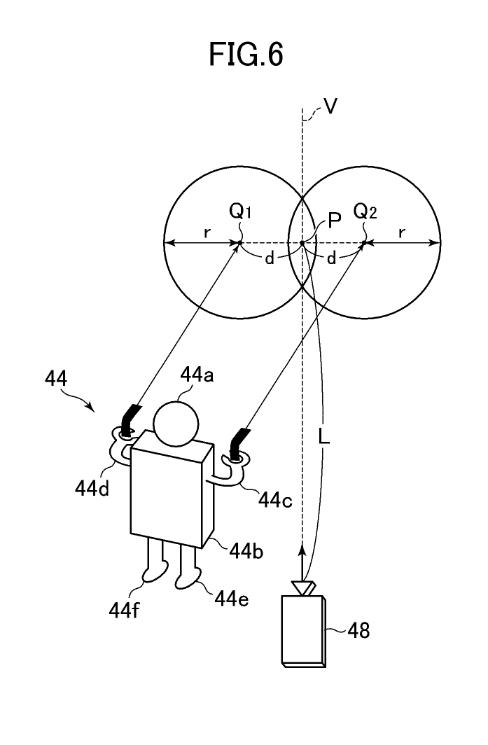

FIG. 6 is a diagram illustrating traveling directions of the bullets. As illustrated in FIG. 6, a position P located away from the position of the virtual camera 48 in a sight line direction V by a first predetermined distance L is set as a reference, and regions within circles each having a predetermined radius r and having, as their centers, positions Q₁ and Q₂ each located away from the position P in a direction perpendicular to the sight line direction V by a second predetermined distance d are respectively set as the impact candidate positions of the bullets. In a case where the player performs the attack instruction operation, the bullet is shot from the position of the left arm 44d of the robot 44 toward an impact position determined randomly within the circle having the position Q₁ as its center, and the bullet is shot from the position of the right arm 44c of the robot 44 toward an impact position determined randomly within the circle having the position Q₂ as its center.

Note that the method of determining the traveling directions of the bullets is not limited to the above-mentioned example. Alternatively, for example, data obtained by associating the display positions of the first sighting image 62 and the second sighting image 64 with the positions within the game space 40 may be stored in the game data storage unit 70, and the bullets may travel toward the positions within the game space 40 associated with the display positions of the first sighting image 62 and the second sighting image 64.

### (3-7. Sighting Control Unit)

The sighting control unit 82 is implemented mainly by the control unit 14. The sighting control unit 82 controls the display positions of the first sighting image 62 and the second sighting image 64 so that an overlapping region of part of the first sighting image 62 and part of the second sighting image 64 includes the center point 66 of the virtual space image (for example, the image of the game space 40 displayed on the game screen 60).

The sighting control unit 82 controls the display position of the first sighting image 62 based on a first representative point, and controls the display position of the second sighting image 64 based on a second representative point. The first representative point is a position associated with the first sighting image 62 (position indicated by the screen coordinate system; for example, the position within the screen), and the second representative point is a position associated with the second sighting image 64. For example, the center point 62a of the first sighting image 62 is set as the first representative point, and the center point 64a of the second sighting image 64 is set as the second representative point. As illustrated in FIG. 3, the display position of the first sighting image 62 is determined so that the distance between the representative point of the first sighting image 62 (for example, the center point 62a) and the center point 66 of the game screen 60 becomes a first predetermined distance or smaller (for example, the radius of the first sighting image 62 or smaller), and the display position of the second sighting image 64 is determined so that the distance between the representative point of the second sighting image 64 (for example, the center point 64b) and the center point 66 of the game screen 60 becomes a second predetermined distance or smaller (for example, the radius of the second sighting image 64 or smaller).

In other words, the display positions of the first sighting image 62 and the second sighting image 64 are controlled to be located in such positions that the first sighting image 62 includes the center point 66 of the game screen 60, and at the same time, the second sighting image 64 includes the center point 66 of the game screen 60. Further, in other words, the first sighting image 62 and the second sighting image 64 have such a positional relationship that in a case where the first sighting image 62 is divided by a center line of the game screen 60, a region of the first sighting image 62 on a first side (for example, a right half side) is larger than a region thereof on a second side (for example, a left half side), and in a case where the second sighting image 64 is divided by the center line, a region of the second sighting image 64 on the second side is larger than a region thereof on the first side.

### 4. Processing Executed by the Game Device)

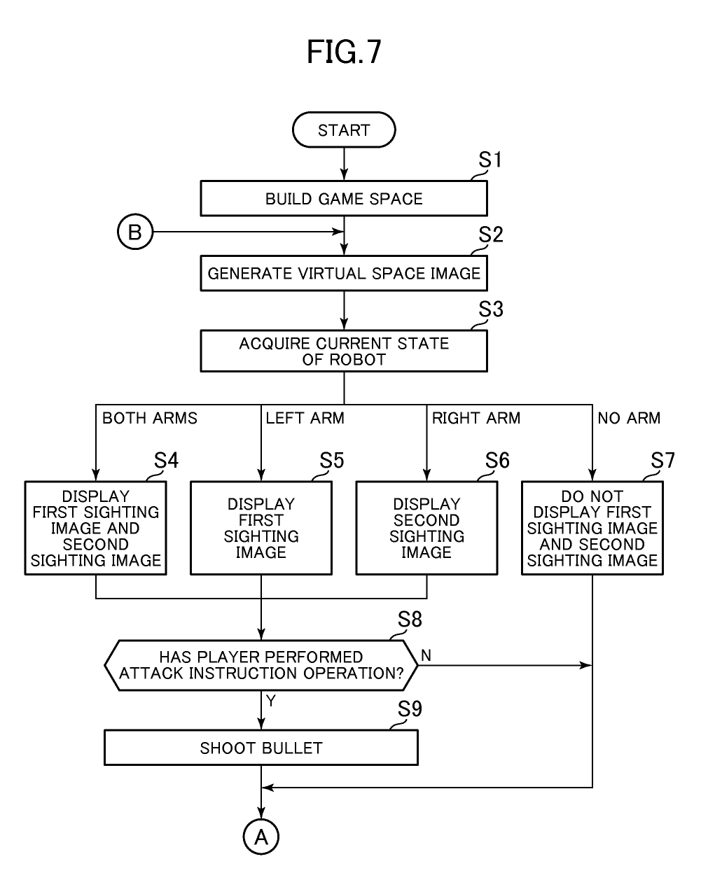

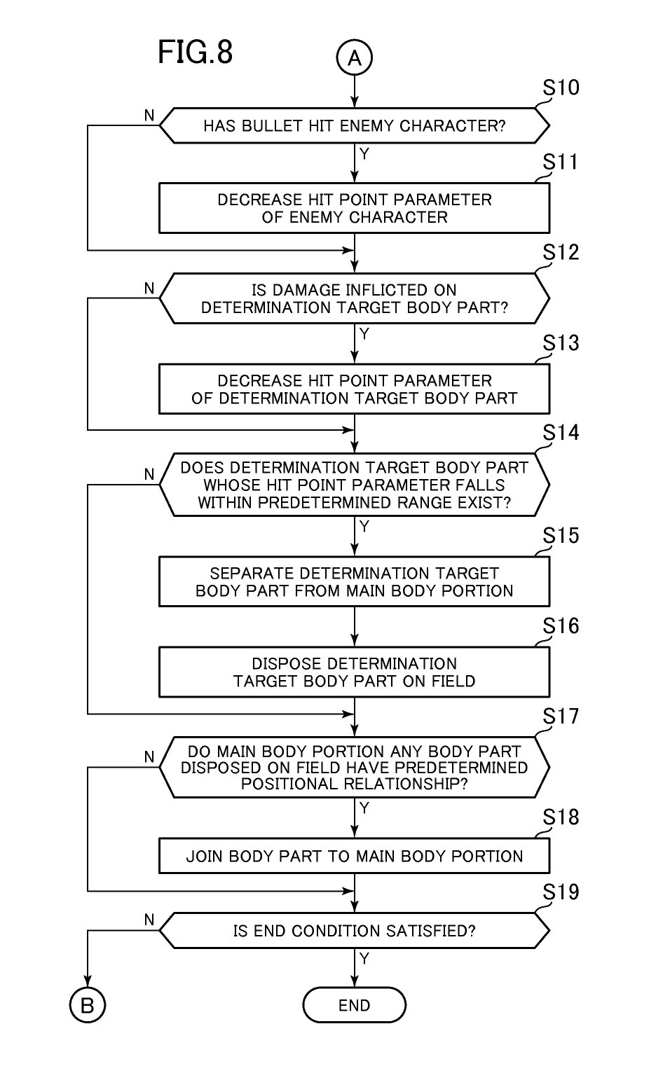

Next, description is given of processing executed by the game device 10. FIGS. 7 and 8 are flowcharts illustrating processing executed in a case where the game is activated in the game device 10. The control unit 14 executes the processing illustrated in FIGS. 7 and 8 in accordance with the program stored in the optical disc 36.

First, in a case where the game is started, the control unit 14 builds the game space 40 in the main memory 16 (S1). In Step S1, the objects are disposed at their initial positions, and parameters indicating current states of the robot 44 and the enemy character 46 are set to initial values. The game situation data is generated based on those initial settings, and the generated game situation data is stored in the main memory 16.

The control unit 14 generates the virtual space image showing how the game space 40 is viewed from the virtual camera 48 (S2). The control unit 14 refers to the game situation data to acquire a current state of the robot 44 (S3). In Step S3, the control unit 14 refers to the restriction target body part flags of the right arm 44c and the left arm 44d of the robot 44, to thereby determine whether or not the right arm 44c and the left arm 44d are connected to the main body portion.

In a case where the right arm 44c and the left arm 44d are connected to the main body portion of the robot 44 (S3; both arms), the control unit 14 determines the display positions of the first sighting image 62 and the second sighting image 64 so that the overlapping region of part of the first sighting image 62 and part of the second sighting image 64 includes the center point of the virtual space image generated in Step S2, and then displays the first sighting image 62 and the second sighting image 64 on the virtual space image in a superimposed manner (S4).

Meanwhile, in a case where only the left arm 44d is connected to the robot 44 (S3; left arm), the control unit 14 determines the display position of the first sighting image 62 so that the first sighting image 62 includes the center point of the virtual space image generated in Step S2, and then displays the first sighting image 62 on the virtual space image in a superimposed manner (S5). In Step S5, the right arm 44c of the robot 44 is separated, and hence a restriction is imposed so that the second sighting image 64 is not displayed.

Meanwhile, in a case where only the right arm 44c is connected to the robot 44 (S3; right arm), the control unit 14 determines the display position of the second sighting image 64 so that the second sighting image 64 includes the center point of the virtual space image generated in Step S2, and then displays the second sighting image 64 on the virtual space image in a superimposed manner (S6). In Step S6, the left arm 44d of the robot 44 is separated, and hence a restriction is imposed so that the first sighting image 62 is not displayed.

Meanwhile, in a case where neither the right arm 44c nor the left arm 44d is connected to the robot 44 (S3; no arm), the control unit 14 imposes a restriction so that the first sighting image 62 and the second sighting image 64 are not displayed on the game screen (S7).

Based on a detection signal from the controller 30, the control unit 14 determines whether or not the player has performed the attack instruction operation (S8). In a case where it is determined that the player has performed the attack instruction operation (S8; Y), the control unit 14 shoots the bullet toward the position within the game space 40 corresponding to the display position of at least one of the first sighting image 62 and the second sighting image 64 displayed on the game screen 60 (S9). In this case, the bullet is shot toward the position determined randomly in the region within the circle (FIG. 6) corresponding to at least one of the first sighting image 62 and the second sighting image 64.

Referring next to FIG. 8, the control unit 14 determines whether or not the bullet shot by the robot 44 has hit the enemy character 46 (S10). In Step S10, the hit determination as to whether the object representing the bullet has hit the enemy character 46 is performed.

In a case where it is determined that the bullet shot by the robot 44 has hit the enemy character 46 (S10; Y), the control unit 14 decreases the hit point parameter of the enemy character 46 by a value determined based on the attacking power of the robot 44 and the defensive power of the enemy character 46 (S11). Note that in a case where the hit point parameter of the enemy character 46 falls within a predetermined range, the robot 44 can defeat the enemy character 46.

The control unit 14 determines whether or not the damage is inflicted on the determination target body part (S12). As a determination method in Step S12, as described above, based on the method determined in advance (for example, the hit determination as to whether or not the robot 44 has come into contact with the enemy character 46), it is determined whether or not the damage is inflicted on the determination target body part.

In a case where the damage is inflicted on the determination target body part (S12; Y), the control unit 14 decreases the hit point parameter of the determination target body part (S13). For example, based on the ability value of the enemy character 46 and the ability value of the robot 44, the control unit 14 decreases the value of the hit point parameter of the determination target body part on which the damage is inflicted, to thereby update the hit point parameter.

The control unit 14 refers to the updated hit point parameter to determine whether or not the determination target body part whose hit point parameter falls within the predetermined range (for example, becomes the reference value or smaller) exists (S14). In a case where the determination target body part whose hit point parameter falls within the predetermined range exists (S14; Y), the control unit 14 separates the determination target body part whose hit point parameter falls within the predetermined range from the main body portion, and then changes the value of the restriction target body part flag to “1” (S15).

The control unit 14 disposes the body part separated from the main body portion on the field 42 (S16). Display processing on the game screen 60 is performed so that the restriction target body part is blown off in a direction in which the attack is made by the enemy character 46, and then the restriction target body part is separated. The position at which the separated restriction target body part is disposed is determined based on, for example, the position of the robot 44 and a moving direction of an attacking medium of the enemy character 46 (for example, the traveling direction of the bullet shot by the enemy character 46). For example, the separated body part is disposed at a position spaced apart in the direction in which the attack is made by a predetermined distance from the position of the robot 44 determined in a case where the damage is inflicted on the determination target body part of the robot 44.

The control unit 14 determines whether or not the main body portion and the body part disposed on the field 42 have a predetermined positional relationship (S17). In Step S17, for example, the control unit 14 refers to the game situation data to determine whether or not a positional relationship between the position of the robot 44 and the position at which the separated body part is disposed satisfies a predetermined condition.

In a case where the main body portion and the body part disposed on the field 42 have the predetermined positional relationship (S17; Y), the control unit 14 joins the body part disposed on the field 42 to the main body portion, and then changes the value of the restriction target body part flag to “0” (S18). In Step S18, a display mode of the robot 44 is updated so that the main body portion of the robot 44 and the above-mentioned restriction target body part are joined to each other.

The control unit 14 determines whether or not a predetermined end condition is satisfied (S19). The end condition only needs to be a condition determined in advance. For example, it is determined whether or not an instruction to end the game has been input by the operation of the player, or whether or not a predetermined condition for completing the game has been satisfied.

In a case where it is determined that the end condition is satisfied (S19; Y), the processing ends. In a case where the end condition is not satisfied (S19; N), the processing returns to Step S2.

According to the game device 10 described above, the first sighting image 62 and the second sighting image 64 are displayed in the vicinity of the center of the screen while the first sighting image 62 and the second sighting image 64 overlap with each other, which enables the player to easily aim at the target. Further, two sighting images of the first sighting image 62 and the second sighting image 64 are displayed, which enables the player to easily have an actual feeling of how the player makes an attack with two guns.

Note that the present invention is not limited to the embodiment described above. Changes can appropriately be made without departing from the gist of the present invention.

### 5. Modified Examples

(1) For example, as in the embodiment, in a case where the game configured so that based on the operation of the player, the robot 44 including the plurality of determination target body parts shoots the moving object from each of the first ejector and the second ejector to make an attack against the enemy character 46 disposed within the game space 40 is executed, the positional relationship between the first sighting image 62 and the second sighting image 64 may be changed depending on a combination of the body parts included in the main body portion of the robot 44.

The game data storage unit 70 according to Modified Example (1) stores a body part condition regarding the combination of the determination target body parts that are included in the main body portion, and positional relationship information relating to the positional relationship between the first sighting image 62 and the second sighting image 64, in association with each other.

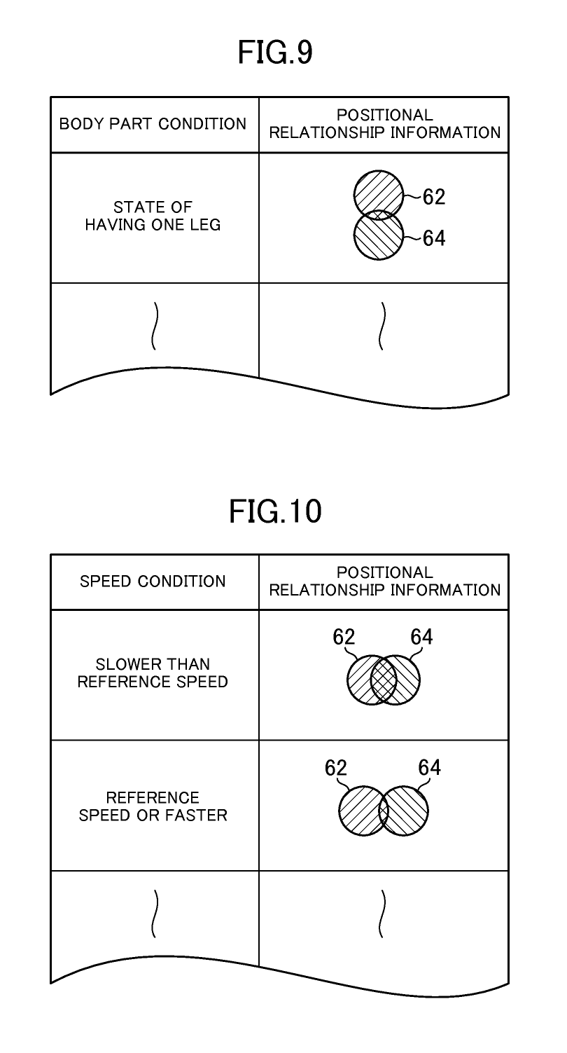

FIG. 9 is a diagram illustrating a data storage example of association between the body part condition and the positional relationship information. As illustrated in FIG. 9, in the body part condition, information indicating the combination of the determination target body parts that are included in the main body portion is stored. In the positional relationship information, information indicating the display position of the first sighting image 62 and the display position of the second sighting image 64, information indicating a distance between the first sighting image 62 and the second sighting image 64 and a direction connecting the display positions thereof, or information indicating an area of the overlapping region of the first sighting image 62 and the second sighting image 64 is stored (the same applies to the positional relationship information to be described in other modified examples.). For example, as illustrated in FIG. 9, in a case where the robot 44 reaches a state in which the robot 44 has only one leg, the first sighting image 62 and the second sighting image 64 are disposed so as to be vertically aligned.

The sighting control unit 82 according to Modified Example (1) controls the display positions of the first sighting image 62 and the second sighting image 64 based on the positional relationship information associated with the body part condition satisfied by a current combination of the determination target body parts that are included in the main body portion. For example, the determination target body parts stored in the game situation data are referred to and the combination of the determination target body parts and the body part condition are compared with each other so that it is determined whether or not the body part condition is satisfied. At the display positions determined based on the positional relationship information associated with the body part condition satisfied by the current combination of the determination target body parts, the first sighting image 62 and the second sighting image 64 are displayed.

According to Modified Example (1), the positional relationship between the first sighting image 62 and the second sighting image 64 is changed depending on the combination of the determination target body parts that are included in the main body portion of the robot 44, and hence it becomes easy or difficult to aim at the target depending on the state of the robot 44.

(2) Further, for example, in a case where the right arm 44c or the left arm 44d of the robot 44 is separated, the right arm 44c or the left arm 44d that has been separated and is disposed on the field 42 may shoot the bullet from its current position.

The operation subject of the player (for example, the robot 44) uses the first ejector (for example, the gun held in the right arm 44c) by using a predetermined body part. The damage determination unit 74 determines whether or not the damage is inflicted on the predetermined body part by the attack made by the enemy character 46, and based on the result of determination obtained by the damage determination unit 74, the separation unit 76 separates the predetermined body part from the main body portion of the robot 44 and disposes the separated predetermined body part in the virtual space (for example, the game space 40).

The moving object control unit 80 includes means for shooting, in a case where the predetermined body part is separated from the main body portion, in response to the operation of the player, the moving object in a representative direction of the first ejector from the position at which the separated predetermined body part is disposed. The representative direction refers to a direction associated with the right arm 44c or the left arm 44d, for example, a direction in which each of the guns is oriented. Information indicating the representative direction is stored in the game situation data.

According to Modified Example (2), even in the case where the right arm 44c or the left arm 44d is separated from the main body portion of the robot 44, it is possible to shoot the bullet from its current position.

(3) Further, for example, in a case where the arm is separated from the robot 44, a layout of the first sighting image 62 and the second sighting image 64 may be changed.

The sighting control unit 82 according to Modified Example (3) includes means for erasing the first sighting image 62 and changing at least one of the display position, a shape, and an area of the second sighting image 64 in the case where the predetermined body part is separated from the main body portion. For example, in a case where the right arm 44c is separated from the main body portion, the above-mentioned means moves the representative point of the first sighting image 62 (for example, the center point 62a of the first sighting image 62) closer to the center point 66 of the game screen 60, to thereby move the display position of the first sighting image 62 closer to the center point 66 of the game screen 60, or lengthens the radius of the first sighting image 62, to thereby change the shape of the first sighting image 62 to a shape having a large area. Similarly, in a case where the left arm 44d is separated from the main body portion, the above-mentioned means moves the representative point of the second sighting image 64 (for example, the center point 64a of the second sighting image 64) closer to the center point 66 of the game screen 60, to thereby move the display position of the second sighting image 64 closer to the center point 66 of the game screen 60, or lengthens the radius of the second sighting image 64, to thereby change the shape of the second sighting image 64 to a shape having a large area.

According to Modified Example (3), it is possible to change the difficulty in aiming at the target in the case where the arm of the robot 44 is separated.

(4) Further, for example, the positional relationship between the first sighting image 62 and the second sighting image 64 may be changed depending on the moving speed of the robot 44 or the virtual camera 48.

The game device 10 according to Modified Example (4) includes means for moving, in response to the operation of the player, at least one of the operation subject (for example, the robot 44) and the virtual viewpoint (for example, the virtual camera 48). The above-mentioned means is realized by, for example, the game execution unit 72. For example, the specifics of the operation of the player and the moving speed of at least one of the robot 44 and the virtual camera 48 are associated with each other. At least one of the robot 44 and the virtual camera 48 moves at the moving speed associated with the specifics of the operation of the player performed through the controller 30.

The game data storage unit 70 according to Modified Example (4) stores a speed condition regarding the moving speed of at least one of the operation subject and the virtual viewpoint, and positional relationship information relating to the positional relationship between the first sighting image 62 and the second sighting image 64, in association with each other.

FIG. 10 is a diagram illustrating a data storage example of association between the speed condition and the positional relationship information. As illustrated in FIG. 10, as the speed condition, conditions indicating whether or not the moving speed of at least one of the robot 44 and the virtual camera 48 falls within a predetermined range are stored. A change in the position of at least one of the robot 44 and the virtual camera 48 is acquired by referring to the game situation data, and it is determined whether or not the speed condition is satisfied by comparing the moving speed of at least one of the robot 44 and the virtual camera 48 with the speed condition.

The sighting control unit 82 according to Modified Example (4) includes means for controlling the display positions of the first sighting image 62 and the second sighting image 64 based on the positional relationship information associated with a condition satisfied by a current moving speed of at least one of the operation subject (for example, the robot 44) and the virtual viewpoint (for example, the virtual camera 48). In this case, a setting is performed so that depending on the moving speed of at least one of the operation subject and the virtual viewpoint, an area of the overlapping region of the first sighting image 62 and the second sighting image 64 is increased or decreased.

The sighting control unit 82 controls the display positions of the first sighting image 62 and the second sighting image 64 so that depending on the moving speed of at least one of the operation subject and the virtual viewpoint, the area of the overlapping region of the first sighting image 62 and the second sighting image 64 is increased or decreased. For example, the display positions of the first sighting image 62 and the second sighting image 64 are determined so that as the moving speed of the robot 44 becomes faster, or as the moving speed of the virtual camera 48 becomes faster, the area of the overlapping region of the first sighting image 62 and the second sighting image 64 is increased or decreased.

According to Modified Example (4), it is possible to change the positional relationship between the first sighting image 62 and the second sighting image 64 depending on the moving speed of the robot 44 or the virtual camera 48, to thereby change the difficulty in aiming at the target.

(5) Further, for example, the positional relationship between the first sighting image 62 and the second sighting image 64 may be varied depending on a combination of weapons with which the robot 44 is armed in the right arm 44c and the left arm 44d.

The operation subject of the player is armed with, of a plurality of kinds of ejectors, kinds of ejectors specified by the player as the first ejector and the second ejector. A plurality of kinds of weapons that can be used by the player are stored in the game data storage unit 70. Information indicating ejectors with which the robot 44 is currently armed may be stored in the game situation data.

The game data storage unit 70 according to Modified Example (5) stores an ejector condition regarding a combination of a kind of the first ejector and a kind of the second ejector and positional relationship information relating to the positional relationship between the first sighting image 62 and the second sighting image 64 in association with each other.

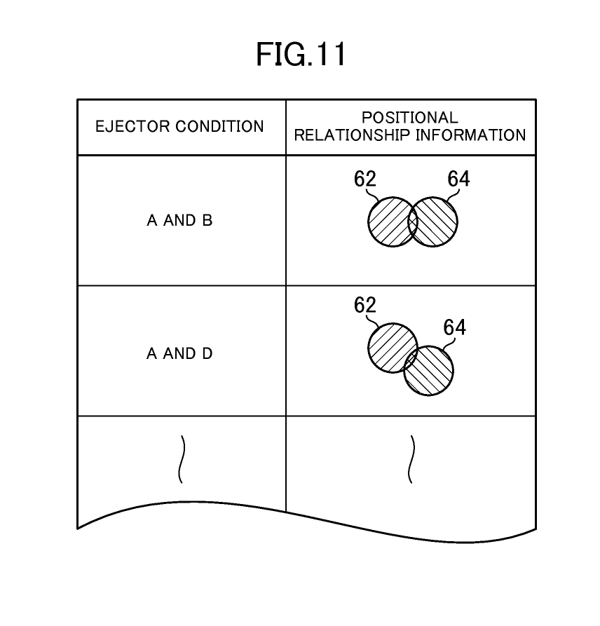

FIG. 11 is a diagram illustrating a data storage example of association between the ejector condition and the positional relationship information. Information indicating a combination of a plurality of weapons is stored in the ejector condition, and, for example, information indicating the compatibility between the plurality of weapons is stored therein. It is then determined whether or not a combination of ejectors selected by the player is a predetermined combination. For example, depending on the combination of ejectors, the first sighting image 62 and the second sighting image 64 are laterally arranged, or diagonally arranged.

The sighting control unit 82 according to Modified Example (5) controls the display positions of the first sighting image 62 and the second sighting image 64 based on the positional relationship information associated with the ejector condition satisfied by a current combination of a kind of the first ejector and a kind of the second ejector. For example, the display positions of the first sighting image 62 and the second sighting image 64 are controlled so that depending on the kind of the first ejector and the kind of the second ejector, the area of the overlapping region of the first sighting image 62 and the second sighting image 64 is increased or decreased.

According to Modified Example (5), it is possible to change the difficulty in aiming at the target depending on whether the compatibility of the combination of the plurality of ejectors selected by the player is good or bad.

(6) Further, for example, the description of the above-mentioned embodiment is directed to the case where the bullet randomly impacts on the region within each of the first sighting image 62 and the second sighting image 64, but as a given point becomes closer to the center of each of the first sighting image 62 and the second sighting image 64, a probability of impacting on the given point may be increased.

The moving object control unit 80 according to Modified Example (6) includes means for shooting the moving object from the first ejector toward a first target position within the virtual space (for example, the game space 40) that is selected based on a display region of the first sighting image 62, and shooting the moving object from the second ejector toward a second target position within the virtual space that is selected based on a display region of the second sighting image 64.

For example, a point within the display region of the first sighting image 62 is selected, and a point within the game space 40 corresponding to the point is selected as the first target position. Similarly, a point within the display region of the second sighting image 64 is selected, and a point within the game space 40 corresponding to the point is selected as the second target position. Alternatively, for example, a point selected from a region within the game space 40 corresponding to the display region of the first sighting image 62 may be set as the first target position, and a point selected from a region within the game space 40 corresponding to the display region of the second sighting image 64 may be set as the second target position.

The moving object control unit 80 further includes means for performing a setting so that as a given point becomes closer to a position within the virtual space (for example, the game space 40) corresponding to the center point 62a of the display region of the first sighting image 62 (see FIG. 3), a probability of the given point being selected as the first target position becomes higher, and performing a setting so that as another given point becomes closer to a position within the virtual space corresponding to the center point 64a of the display region of the second sighting image 64, a probability of the other given point being selected as the second target position becomes higher.

For example, in a case where, of a first position and a second position within the display region of the first sighting image 62, the first position is closer to the center point 62a, a probability of a position within the game space 40 corresponding to the first position being selected as the first target position is set higher than a probability of a position within the game space 40 corresponding to the second position being selected as the first target position. Similarly, in a case where, of a third position and a fourth position within the display region of the second sighting image 64, the third position is closer to the center point 64a, a probability of a position within the game space 40 corresponding to the third position being selected as the second target position is set higher than a probability of a position within the game space 40 corresponding to the fourth position being selected as the second target position. Data indicating the probabilities of being selected which are defined as described above is stored in advance in the game data storage unit 70.

According to Modified Example (6), in a case where the player aims at the centers of the first sighting image 62 and the second sighting image 64, it is possible to increase a probability of impacting on the target as the player desires.

(7) Further, for example, the description is directed to the case where the hit point parameter is not set for the main body part, but in a case where the attack made by the enemy character 46 has hit the main body part, a predetermined value may be subtracted from the hit point parameters of the body parts other than the main body part. With this configuration, in a case where the main body part is subjected to a strong attack, control is performed so that the robot 44 is broken apart into pieces.

(8) Further, for example, the description is directed to the case where the head 44a of the robot 44 is set as the main body part, but the main body part may be determined based on the value of the hit point parameter. Specifically, for example, of the determination target body parts of the robot 44, a body part having the largest value of the hit point parameter may be set as the main body part.

In this case, the game device 10 includes means for identifying, for example, of the determination target body parts of the robot 44, a body part whose inflicted damage is the smallest and setting the main body portion so that the main body portion includes at least the identified body part. With the above-mentioned setting of the main body portion, the determination target body parts on which the damage are inflicted is sequentially separated, and finally, for example, only a body part whose value of the hit point parameter does not fall within a predetermined range remains connected to the main body portion.

(9) Further, for example, the body part of the robot 44 may be set as the restriction target body part through the operation of the player. Specifically, for example, in a case where the enemy character 46 exists in a position to which the robot 44 cannot move, the right arm 44c of the robot 44 may be separated and the separated right arm 44c may be thrown toward the position through the operation of the player so that the robot 44 can make an attack against the enemy character 46 existing in the position to which the robot 44 cannot move. In this case, for example, in a case where the enemy character 46 is defeated, the value of the restriction target body part flag may be set to “0”. Moreover, only one of the right arm 44c and the left arm 44d may be set as the restriction target body part.

(10) Further, for example, the game space 40 is described as such a three-dimensional space as illustrated in FIG. 2, but the game space according to the present invention may be a two-dimensional game space in which the robot 44, the enemy character 46, and the like are managed by two coordinate elements.

(11) Further, for example, the description is directed to the case where the game character is the robot 44, but the game character only needs to be a game character to be the operation subject of the player, and the game character according to the present invention may be a human-shaped one and is not limited thereto. Moreover, the description is directed to the case where the ejector is a weapon for making an attack against the enemy, but it suffices that a member for shooting the moving object (which may be such things as an arrow or a beam as well as the bullet) is used as the ejector. For example, the present invention may be applied to a game device for executing such a game as clay shooting.

(12) Further, for example, the description is directed to the case where each of the first sighting image 62 and the second sighting image 64 has a circular shape, but the shape of each of the first sighting image 62 and the second sighting image 64 is not limited to a circular shape, and may be another shape (for example, quadrangular shape or hexagonal shape). Moreover, the operation of shooting the moving object from the first ejector and the operation of shooting the moving object from the second ejector may be the same operation, or may be different operations.

(13) Note that the description of the above-mentioned embodiment is directed to the case where the virtual space image showing how the game space 40 is viewed is displayed on the entire screen of the display unit 32, but the virtual space image may be displayed on only part of the screen, and a status and the like of the robot 44 may be displayed in a remaining region (for example, region occupying ¼ of the screen from a right end). In this case, the first sighting image 62 and the second sighting image 64 are displayed so that the overlapping region thereof includes the center point of the virtual space image, and hence the first sighting image 62 and the second sighting image 64 are displayed to the left of the entire screen.

(14) Further, for example, the present invention can also be applied to a game device for executing a game other than the third person shooter game. That is, the present invention can be applied to a game configured so that a game character including a plurality of body parts moves within a game space. For example, the present invention can also be applied to a game device for executing a first person shooter game or a role-playing game. Note that in a case where the first person shooter game is executed, the operation subject may not be disposed in the virtual space.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A game device for executing a game configured so that a moving object is shot from each of a first ejector and a second ejector based on an operation of a player, the game device comprising:
display control means for causing display means to display a virtual space image showing how a virtual space is viewed from a virtual viewpoint, and causing the display means to display a first sighting image indicating a sighting of the first ejector and a second sighting image indicating a sighting of the second ejector on the virtual space image in a superimposed manner;
moving object control means for, based on the operation of the player, shooting the moving object from the first ejector toward a position within the virtual space corresponding to a display position of the first sighting image, and shooting the moving object from the second ejector toward a position within the virtual space corresponding to a display position of the second sighting image; and
sighting control means for controlling the display position of the first sighting image and the display position the second sighting image so that an overlapping region of part of the first sighting image and part of the second sighting image includes a center point of the virtual space image.

2. The game device according to claim 1, wherein:
the game comprises a game configured so that, based on the operation of the player, an operation subject including a plurality of determination target body parts shoots the moving object from the each of the first ejector and the second ejector to make an attack against an enemy disposed within the virtual space;
the game device further comprises:
damage determination means for determining, for each of the plurality of determination target body parts, whether or not damage is inflicted on the each of the plurality of determination target body parts by an attack made by the enemy;
means for separating, based on a result of determination obtained by the damage determination means, one of the plurality of determination target body parts from a main body portion of the operation subject; and
means for acquiring, from means for storing a body part condition regarding a combination of ones of the plurality of determination target body parts that are included in the main body portion, and positional relationship information relating to a positional relationship between the first sighting image and the second sighting image, in association with each other, the positional relationship information; and
the sighting control means controls the display position of the first sighting image and the display position of the second sighting image based on the positional relationship information associated with the body part condition satisfied by a current combination of the ones of the plurality of determination target body parts that are included in the main body portion.

3. The game device according to claim 1, wherein:
the game comprises a game configured so that, based on the operation of the player, an operation subject shoots the moving object from the each of the first ejector and the second ejector to make an attack against an enemy disposed within the virtual space;
the operation subject uses the first ejector by using a predetermined body part;
the game device further comprises:
damage determination means for determining whether or not damage is inflicted on the predetermined body part by an attack made by the enemy; and
means for separating, based on a result of determination obtained by the damage determination means, the predetermined body part from a main body portion of the operation subject, and disposing the separated predetermined body part in the virtual space; and
the moving object control means shoots, in a case where the predetermined body part is separated from the main body portion, in response to the operation of the player, the moving object in a representative direction of the first ejector from a position at which the separated predetermined body part is disposed.

4. The game device according to claim 3, wherein the sighting control means comprises means for erasing the first sighting image and changing at least one of the display position, a shape, and an area of the second sighting image in the case where the predetermined body part is separated from the main body portion.

5. The game device according to claim 1, wherein:
the game comprises a game configured so that based on the operation of the player, an operation subject shoots the moving object from the each of the first ejector and the second ejector;
the game device further comprises:
means for moving, in response to the operation of the player, at least one of the operation subject and the virtual viewpoint; and
means for acquiring, from means for storing a speed condition regarding a moving speed of the at least one of the operation subject and the virtual viewpoint, and positional relationship information relating to a positional relationship between the first sighting image and the second sighting image, in association with each other, the positional relationship information; and
the sighting control means controls the display position of the first sighting image and the display position of the second sighting image based on the positional relationship information associated with the speed condition satisfied by a current moving speed of the at least one of the operation subject and the virtual viewpoint.

6. The game device according to claim 5, wherein:
an association between the speed condition and the positional relationship information is set so that depending on the moving speed of the at least one of the operation subject and the virtual viewpoint, an area of the overlapping region of the first sighting image and the second sighting image is increased or decreased; and
the sighting control means controls the display position of the first sighting image and the display position of the second sighting image based on the positional relationship information associated with the speed condition satisfied by the current moving speed of the at least one of the operation subject and the virtual viewpoint, to thereby control the display position of the first sighting image and the display position of the second sighting image so that depending on the moving speed of the at least one of the operation subject and the virtual viewpoint, the area of the overlapping region of the first sighting image and the second sighting image is increased or decreased.

7. The game device according to claim 1, wherein:
in the game, of a plurality of kinds of ejectors, ones of the plurality of kinds of ejectors specified by the player are used as the first ejector and the second ejector;
the game device further comprises means for acquiring, from means for storing an ejector condition regarding a combination of a kind of the first ejector and a kind of the second ejector, and positional relationship information relating to a positional relationship between the first sighting image and the second sighting image, in association with each other, the positional relationship information; and
the sighting control means controls the display position of the first sighting image and the display position of the second sighting image based on the positional relationship information associated with the ejector condition satisfied by a current combination of the kind of the first ejector and the kind of the second ejector.

8. The game device according to claim 7, wherein:
an association between the ejector condition and the positional relationship information is set so that depending on the combination of the kind of the first ejector and the kind of the second ejector, an area of the overlapping region of the first sighting image and the second sighting image is increased or decreased; and
the sighting control means controls the display position of the first sighting image and the display position of the second sighting image based on the positional relationship information associated with the ejector condition satisfied by the current combination of the kind of the first ejector and the kind of the second ejector, to thereby control the display position of the first sighting image and the display position of the second sighting image so that depending on the combination of the kind of the first ejector and the kind of the second ejector, the area of the overlapping region of the first sighting image and the second sighting image is increased or decreased.

9. The game device according to claim 1, wherein the moving object control means comprises:
means for shooting the moving object from the first ejector toward a first target position within the virtual space that is selected based on a display region of the first sighting image, and shooting the moving object from the second ejector toward a second target position within the virtual space that is selected based on a display region of the second sighting image; and
means for performing a setting so that as a given point becomes closer to a position within the virtual space corresponding to a center point of the display region of the first sighting image, a probability of the given point being selected as the first target position becomes higher, and performing a setting so that as another given point becomes closer to a position within the virtual space corresponding to a center point of the display region of the second sighting image, a probability of the other given point being selected as the second target position becomes higher.

10. A method of controlling a game device for executing a game configured so that a moving object is shot from each of a first ejector and a second ejector based on an operation of a player, the method comprising:
a display control step of causing display means to display a virtual space image showing how a virtual space is viewed from a virtual viewpoint, and causing the display means to display a first sighting image indicating a sighting of the first ejector and a second sighting image indicating a sighting of the second ejector on the virtual space image in a superimposed manner;
a moving object control step of, based on the operation of the player, shooting the moving object from the first ejector toward a position within the virtual space corresponding to a display position of the first sighting image, and shooting the moving object from the second ejector toward a position within the virtual space corresponding to a display position of the second sighting image; and
a sighting control step of controlling the display position of the first sighting image and the display position of the second sighting image so that an overlapping region of part of the first sighting image and part of the second sighting image includes a center point of the virtual space image.

11. A non-transitory computer readable information storage medium having recorded thereon a program for causing a computer to function as a game device for executing a game configured so that a moving object is shot from each of a first ejector and a second ejector based on an operation of a player, the program causing the computer to function as:
display control means for causing display means to display a virtual space image showing how a virtual space is viewed from a virtual viewpoint, and causing the display means to display a first sighting image indicating a sighting of the first ejector and a second sighting image indicating a sighting of the second ejector on the virtual space image in a superimposed manner;
moving object control means for, based on the operation of the player, shooting the moving object from the first ejector toward a position within the virtual space corresponding to a display position of the first sighting image, and shooting the moving object from the second ejector toward a position within the virtual space corresponding to a display position of the second sighting image; and
sighting control means for controlling the display position of the first sighting image and the display position of the second sighting image so that an overlapping region of part of the first sighting image and part of the second sighting image includes a center point of the virtual space image.
